(19) United States
(12) Patent Application Publication
(10) Pub. No.: US 2026/0343453 A1
(43) Pub. Date: Oct. 29, 2026

(54) TIMING ADVANCE TA DETERMINING METHOD AND COMMUNICATION APPARATUS

(71) Applicant: HUAWEI TECHNOLOGIES CO., LTD., Shenzhen (CN)

(72) Inventors: Ying Chen, Hangzhou (CN); Jun Wang, Hangzhou (CN)

(73) Assignee: HUAWEI TECHNOLOGIES CO., LTD., Shenzhen (CN)

(21) Appl. No.: 19/569,527

(22) Filed: Mar. 17, 2026

Related U.S. Application Data
(63) Continuation of application No. PCT/CN2024/121660, filed on Sep. 27, 2024.

(30) Foreign Application Priority Data
Sep. 27, 2023 (CN) 202311270998.2

(51) Int. Cl. H04W 56/00; H04W 4/02; H04W 4/029

(52) U.S. Cl. CPC H04W 56/0045; H04W 4/027; H04W 4/029

(57) ABSTRACT

Embodiments of this disclosure provides a timing advance (TA) determining method and a communication apparatus. The method includes: A terminal device receives a first timing advance command (TAC) at a first moment. In response to that a first parameter is updated in a first time period before the first moment, the terminal device determines a TA adjustment value based on a component of a first timing advance and the first TAC. The terminal device further communicates with a serving satellite based on the TA adjustment value. The first timing advance is determined by the terminal device at a second moment, the first time period is a time period between the second moment and the first moment, and the first parameter includes one or more pieces of the following information: positioning information of the terminal device, ephemeris information of the serving satellite, or a common timing advance TA.

### CROSS-REFERENCE TO RELATED APPLICATIONS

This application is a continuation of International Application No. PCT/CN2024/121660, filed on Sep. 27, 2024, which claims priority to Chinese Patent Application No. 202311270998.2, filed on Sep. 27, 2023. The disclosures of the aforementioned applications are hereby incorporated by reference in their entireties.

### TECHNICAL FIELD

Embodiments of this disclosure relate to the field of communication technologies, and in particular, to a timing advance TA determining method and a communication apparatus.

### BACKGROUND

Because different user equipment (UE) devices are at different distances from a base station, uplink information sent by the different UE devices arrive at the base station at different moments, and signal interference occurs. Therefore, the base station expects that time at which signals from the different UE devices in a same subframe arrive at the base station is basically aligned, so that the base station can correctly receive uplink data sent by the UE device. To correctly receive the uplink data from the UE device by the base station, a timing advance (TA) is introduced.

In terrestrial communication, the base station may estimate a TA of the UE device based on a random access preamble sent by the UE device (TAs for UE devices at different distances from the base station are different), and then notify the UE device of a timing advance command (TAC), and the UE device may determine a TA adjustment value based on the TAC. Different UE devices send uplink data based on different corresponding TA adjustment values. From a perspective of the base station, if all uplink/downlink system frames are aligned, the base station may receive uplink data from a plurality of UE devices in a same subframe. The foregoing TAC mechanism may be understood as a closed-loop TA adjustment mechanism.

However, in satellite communication, a distance between a satellite and a UE device is long, and a delay is long, making a TA adjustment value determined only based on a TAC inaccurate. Therefore, an open-loop TA adjustment mechanism is additionally introduced to ensure uplink synchronization in satellite communication. In the open-loop TA adjustment mechanism, a terminal needs to calculate a round-trip transmission delay from the terminal to the satellite based on ephemeris information and geographical location information of the terminal, use the delay as open-loop TA adjustment information when sending an uplink signal, and use closed-loop timing advance adjustment of a TAC to compensate for an error of the open-loop TA adjustment information, to determine a TA adjustment value.

In satellite communication, after receiving a TAC, the terminal determines a current TA by accumulating a last TA (the TA may compensate for an error of a global navigation satellite system (GNSS), ephemeris information, and common TA information); and when the terminal performs location update or monitors the ephemeris information, the error of the ephemeris information, the common TA information, and the GNSS may be accumulated to the TA again. These two aspects cause a TA error jump, and consequently, a determined TA adjustment value is inaccurate.

### SUMMARY

This disclosure provides a timing advance TA determining method and a communication apparatus, to reduce an error jump during determining of a TA adjustment value, and improve accuracy of the TA adjustment value.

According to a first aspect, this disclosure provides a timing advance TA determining method. The method may be performed by a terminal device. The terminal device may be understood as a UE device, a vehicle-mounted device, a chip of the terminal, or the like. A type of the terminal is not limited herein in this disclosure. The terminal may communicate with a satellite. In this disclosure, the satellite may be a geostationary satellite, a non-geostationary satellite, an artificial satellite, a low earth orbit satellite, a medium earth orbit satellite, a high earth orbit satellite, or the like. This is not limited herein in this disclosure. The method includes: A terminal device receives a first timing advance command TAC at a first moment. If a first parameter is updated in a first time period before the first moment, the terminal device determines a TA adjustment value based on a component of a first timing advance and the first TAC. The first timing advance is determined by the terminal device at a second moment, the first time period is a time period between the second moment and the first moment, and the first parameter includes one or more pieces of the following information: positioning information of the terminal device, ephemeris information of a serving satellite, and a common timing advance TA. The terminal device communicates with the serving satellite based on the TA adjustment value.

In an embodiment, an update of the first parameter is used as a trigger condition to reduce error compensation in a closed-loop TA adjustment mechanism (a TA corresponding to a TAC), so that an error jump during determining of the TA adjustment value can be reduced, and accuracy of the TA adjustment value can be ensured.

In an embodiment, the TA adjustment value T_{TA} satisfies the following relational expression:

T_{TA}=(N_{TA_new}+N_{TA,UE-specific}+N_{TA,common}+N_{TA,offset})×T_{c}

$${N}_{TA \_ new} = α \times {N}_{{TA}_{old}} + ( {T}_{A} - 31 ) \times \frac{16.64}{{2}^{μ}} ,$$

and N_{TA_old} is the first timing advance, α×N_{TA_old} represents the component of the first timing advance, 0≤α<1, T_{A} is a timing advance determined based on the first TAC, μ is a coefficient determined based on a subcarrier spacing corresponding to the terminal device, N_{TA,UE-specific} is a timing advance determined based on the ephemeris information of the serving satellite and the positioning information of the terminal device, N_{TA,common} is a timing advance associated with the common TA information, N_{TA,offset} is a preconfigured timing offset, and T_{c} is a minimum time unit.

The foregoing method may be applied to a communication scenario. In different communication scenarios, information included in the first parameter may be different. The following describes in detail information of the first parameter in different communication scenarios.

In an embodiment, the serving satellite is a geostationary earth orbit GEO satellite, and the first parameter includes the positioning information of the terminal device.

In an embodiment, the serving satellite is a low earth orbit LEO satellite, and the terminal device is in a stationary state. In this case, the first parameter includes the ephemeris information of the serving satellite.

In an embodiment, the serving satellite is a low earth orbit LEO satellite, and the terminal device is in a moving state. In this case, the first parameter includes the positioning information of the terminal device and/or the ephemeris information of the serving satellite. In an embodiment, the information included in the first parameter is related to one or more of a moving speed of the terminal device, an orbital altitude of the serving satellite, an error of ephemeris information, and an error of the positioning information. Some examples are as follows:
if the moving speed of the terminal device is greater than a first speed threshold, the first parameter includes the positioning information of the terminal device and the ephemeris information of the serving satellite; if the moving speed of the terminal device is less than a second speed threshold, the first parameter includes the ephemeris information of the serving satellite; if the orbital altitude of the serving satellite is less than a first altitude threshold, the first parameter includes the ephemeris information of the serving satellite; if the orbital altitude of the serving satellite is greater than a second altitude threshold, the first parameter includes the positioning information of the terminal device; if the moving speed of the terminal device is greater than the first speed threshold, and the orbital altitude of the serving satellite is greater than the second altitude threshold, the first parameter includes the positioning information of the terminal device; if the moving speed of the terminal device is less than the second speed threshold, and the orbital altitude of the serving satellite is less than the first altitude threshold, the first parameter includes the ephemeris information of the serving satellite; if the error corresponding to the ephemeris information of the serving satellite is less than a first error threshold, the first parameter includes the positioning information of the terminal device; or if the error corresponding to the positioning information of the terminal device is less than a second error threshold, the first parameter includes the ephemeris information of the terminal device.

In an embodiment, the threshold in the foregoing design may be indicated by the serving satellite to the terminal device, or may be predefined or preconfigured in the terminal device. For example, before determining the TA adjustment value, the terminal device may further perform the following operation: receiving first information from the serving satellite, where the first information indicates one or more of the following: the first speed threshold, the second speed threshold, the first altitude threshold, the second altitude threshold, the first error threshold, and the second error threshold.

According to a second aspect, this disclosure provides a timing advance TA determining method. The method may be performed by a terminal device. The terminal device may be understood as a UE device, a vehicle-mounted device, a chip of the terminal, or the like. A type of the terminal is not limited herein in this disclosure. The terminal may communicate with a satellite. In this disclosure, the satellite may be a geostationary satellite, a non-geostationary satellite, an artificial satellite, a low earth orbit satellite, a medium earth orbit satellite, a high earth orbit satellite, or the like. This is not limited herein in this disclosure.

The method includes: A terminal device receives first information, where the first information indicates I moments at which the terminal device sends a random access sequence, an interval between every two moments in the I moments are the same, and I is a positive integer greater than 1. The terminal device sends the random access sequence at an i^{th} moment in the I moments, and receives a second timing advance command TAC at a third moment, where the third moment is a moment between the i^{th} moment and an (i+1)^{th} moment, and i is a positive integer ranging from 1 to I−1. The terminal device determines a TA adjustment value based on the second TAC, where a second timing advance is determined by the terminal device before the third moment. The terminal device communicates with a serving satellite based on the TA adjustment value.

In an embodiment, a feature that N_{TA} accumulated based on a historical TAC returns to zero when the terminal device sends the random access sequence is used to configure periodic sending of the random access sequence, to periodically reduce error compensation in the closed-loop TA adjustment mechanism for a plurality of times, so that an error jump during determining of the TA adjustment value can be reduced, and accuracy of the TA adjustment value can be ensured.

In an embodiment, the second TAC is a 1^{st} TAC received by the terminal device after the i^{th} moment. In an embodiment, validity time of the TA adjustment value determined based on the second TAC is a time period between the third moment and a moment at which a next TAC of the second TAC is received.

In an embodiment, the TA adjustment value T_{TA} satisfies the following relational expression:

T_{TA}=(N_{TA}+N_{TA,UE-specific}+N_{TA,common}+N_{TA,offset})×T_{c}

$${N}_{TA} = ( {T}_{A} - 31 ) \times \frac{16.64}{{2}^{μ}} ,$$

T_{A} is a timing advance determined based on the second TAC, and μ is a coefficient determined based on a subcarrier spacing corresponding to the terminal device; and N_{TA,UE-specific} is a timing advance determined based on ephemeris information of the serving satellite and positioning information of the terminal device, N_{TA,common} is a timing advance associated with common TA information, N_{TA,offset} is a preconfigured timing offset, and T_{c} is a minimum time unit.

In an embodiment, before receiving the first information, the terminal device may further send second information to the serving satellite, where the second information indicates the validity time of the positioning information of the terminal device, and the second information is used to determine the interval between every two moments in the I moments.

According to a third aspect, this disclosure provides a timing advance TA determining method. The method may be performed by a terminal device. The terminal device may be understood as a UE device, a vehicle-mounted device, a chip of the terminal, or the like. A type of the terminal is not limited herein in this disclosure. The terminal may communicate with a satellite. In this disclosure, the satellite may be a geostationary satellite, a non-geostationary satellite, an artificial satellite, a low earth orbit satellite, a medium earth orbit satellite, a high earth orbit satellite, or the like. This is not limited herein in this disclosure.

The method includes: When determining to update a first parameter, a terminal device sends second information to a serving satellite, where the second information is used to request configuration information of a random access sequence, and the first parameter includes one or more pieces of the following information: positioning information of the terminal device, ephemeris information of the serving satellite, and common timing advance TA information. The terminal device sends the random access sequence based on received configuration information of the random access sequence. The terminal device receives a third timing advance command TAC, and determines a TA adjustment value based on the third TAC, where the third TAC is a 1^{st} TAC received by the terminal device after the terminal device sends the random access sequence. The terminal device communicates with the serving satellite based on the TA adjustment value.

In an embodiment, the terminal device uses a feature that corresponding N_{TA} accumulated based on a historical TAC returns to zero when the random access sequence is sent to request a network side to send the random access sequence in an update process of the positioning information or the ephemeris information, to reduce error compensation in a closed-loop TA adjustment mechanism, so that an error jump during determining of the TA adjustment value can be reduced, and accuracy of the TA adjustment value can be ensured.

In an embodiment, the TA adjustment value T_{TA} satisfies the following relational expression:

T_{TA}=(N_{TA}+N_{TA,UE-specific}+N_{TA,common}+N_{TA,offset})×T_{c}

$${N}_{TA} = ( {T}_{A} - 31 ) \times \frac{16.64}{{2}^{μ}} ,$$

T_{A} is a timing advance determined based on the third TAC, and μ is a coefficient determined based on a subcarrier spacing corresponding to the terminal device; and N_{TA,UE-specific} is a timing advance determined based on the ephemeris information of the serving satellite and the positioning information of the terminal device, N_{TA,common} is a timing advance associated with the common TA information, N_{TA,offset} is a preconfigured timing offset, and T_{c} is a minimum time unit.

According to a fourth aspect, this disclosure provides a communication apparatus. The apparatus may be configured to perform the method in the first aspect. The apparatus may be a terminal device, or the apparatus may be a component (for example, a chip, a chip system, or a circuit) in the terminal device, or may be an apparatus that can be used in a matching manner with the terminal device.

In an embodiment, the communication apparatus may include modules or units that perform the corresponding method/operations/steps/actions described in the first aspect. The module or unit may be implemented by a hardware circuit, software, or a combination of the hardware circuit and the software. In an embodiment, the apparatus may include a processing unit (which may also be referred to as a processing module) and a communication unit (which may also be referred to as a communication module). The communication unit may be configured to perform a receiving and/or sending function, and the processing unit may be configured to perform the method in the first aspect or any possible implementation of the first aspect.

An example in which the communication apparatus includes a communication module and a processing module is used. For functions of the modules, refer to the following understanding.

The communication module is configured to receive a first timing advance command TAC at a first moment.

The processing module is configured to: when a first parameter is updated in a first time period before the first moment, determine a TA adjustment value based on a component of a first timing advance and the first TAC, where the first timing advance is determined by a terminal device at a second moment, the first time period is a time period between the second moment and the first moment, and the first parameter includes one or more pieces of the following information: positioning information of the terminal device, ephemeris information of a serving satellite, and a common timing advance TA.

The communication module is further configured to communicate with the serving satellite based on the TA adjustment value.

In an embodiment, the TA adjustment value T_{TA} satisfies the following relational expression:

T_{TA}=(N_{TA_new}+N_{TA,UE-specific}+N_{TA,common}+N_{TA,offset})×T_{c}

$${N}_{TA \_ new} = α \times {N}_{{TA}_{old}} + ( {T}_{A} - 31 ) \times \frac{16.64}{{2}^{μ}} ,$$

N_{TA_old} is the first timing advance, α×N_{TA_old} represents the component of the first timing advance, 0≤α<1, T_{A} is a timing advance determined based on the first TAC, μ is a coefficient determined based on a subcarrier spacing corresponding to the terminal device, N_{TA,UE-specific} is a timing advance determined based on the ephemeris information of the serving satellite and the positioning information of the terminal device, N_{TA,common} is a timing advance associated with the common TA information, N_{TA,offset} is a preconfigured timing offset, and T_{c} is a minimum time unit.

The communication apparatus may be applied to a communication scenario. In different communication scenarios, information included in the first parameter may be different. The following describes in detail information of the first parameter in different communication scenarios.

In an embodiment, the serving satellite is a geostationary earth orbit GEO satellite, and the first parameter includes the positioning information of the terminal device.

In an embodiment, the serving satellite is a low earth orbit LEO satellite, and the terminal device is in a stationary state. In this case, the first parameter includes the ephemeris information of the serving satellite.

In an embodiment, the serving satellite is a low earth orbit LEO satellite, and the terminal device is in a moving state. In this case, the first parameter includes the positioning information of the terminal device and/or the ephemeris information of the serving satellite. In an embodiment, the information included in the first parameter is related to one or more of a moving speed of the terminal device, an orbital altitude of the serving satellite, an error of ephemeris information, and an error of the positioning information. Some examples are as follows: if the moving speed of the terminal device is greater than a first speed threshold, the first parameter includes the positioning information of the terminal device and the ephemeris information of the serving satellite; if the moving speed of the terminal device is less than a second speed threshold, the first parameter includes the ephemeris information of the serving satellite; if the orbital altitude of the serving satellite is less than a first altitude threshold, the first parameter includes the ephemeris information of the serving satellite; if the orbital altitude of the serving satellite is greater than a second altitude threshold, the first parameter includes the positioning information of the terminal device; if the moving speed of the terminal device is greater than the first speed threshold, and the orbital altitude of the serving satellite is greater than the second altitude threshold, the first parameter includes the positioning information of the terminal device; if the moving speed of the terminal device is less than the second speed threshold, and the orbital altitude of the serving satellite is less than the first altitude threshold, the first parameter includes the ephemeris information of the serving satellite; if the error corresponding to the ephemeris information of the serving satellite is less than a first error threshold, the first parameter includes the positioning information of the terminal device; or if the error corresponding to the positioning information of the terminal device is less than a second error threshold, the first parameter includes the ephemeris information of the terminal device.

In an embodiment, the threshold in the foregoing design may be indicated by the serving satellite to the terminal device, or may be predefined or preconfigured in the terminal device. For example, before determining the TA adjustment value, the terminal device may further perform the following operation: receiving first information from the serving satellite, where the first information indicates one or more of the following: the first speed threshold, the second speed threshold, the first altitude threshold, the second altitude threshold, the first error threshold, and the second error threshold.

According to a fifth aspect, the apparatus may be configured to perform the method in the second aspect. The apparatus may be a terminal device, or the apparatus may be a component (for example, a chip, a chip system, or a circuit) in the terminal device, or may be an apparatus that can be used in a matching manner with the terminal device.

In an embodiment, the communication apparatus may include modules or units that perform the corresponding method/operations/steps/actions described in the second aspect. The module or unit may be implemented by a hardware circuit, software, or a combination of the hardware circuit and the software. In an embodiment, the apparatus may include a processing unit (which may also be referred to as a processing module) and a communication unit (which may also be referred to as a communication module). The communication unit may be configured to perform a receiving and/or sending function, and the processing unit may be configured to perform the method in the second aspect or any possible implementation of the second aspect.

An example in which the communication apparatus includes a communication module and a processing module is used. For functions of the modules, refer to the following understanding.

The communication module is configured to: receive first information, where the first information indicates I moments at which a terminal device sends a random access sequence, an interval between every two moments in the I moments are the same, and I is a positive integer greater than 1; and send the random access sequence at an i^{th} moment in the I moments, and receive a second timing advance command TAC at a third moment, where the third moment is a moment between the i^{th} moment and an (i+1)^{th} moment, and i is a positive integer ranging from 1 to I−1.

The processing module is configured to determine a TA adjustment value based on the second TAC, where a second timing advance is determined by the terminal device before the third moment.

The communication module is further configured to communicate with a serving satellite based on the TA adjustment value.

In an embodiment, the second TAC is a 1^{st} TAC received by the terminal device after the i^{th} moment. In an embodiment, validity time of the TA adjustment value determined based on the second TAC is a time period between the third moment and a moment at which a next TAC of the second TAC is received.

In an embodiment, the TA adjustment value T_{TA} satisfies the following relational expression:

T_{TA}=(N_{TA}+N_{TA,UE-specific}+N_{TA,common}+N_{TA,offset})×T_{c}

$${N}_{TA} = ( {T}_{A} - 31 ) \times \frac{16.64}{{2}^{μ}} ,$$

T_{A} is a timing advance determined based on the second TAC, and μ is a coefficient determined based on a subcarrier spacing corresponding to the terminal device; and N_{TA,UE-specific} is a timing advance determined based on ephemeris information of the serving satellite and positioning information of the terminal device, N_{TA,common} is a timing advance associated with common TA information, N_{TA,offset} is a preconfigured timing offset, and T_{c} is a minimum time unit.

In an embodiment, the communication module is further configured to: before receiving the first information, send second information to the serving satellite, where the second information indicates the validity time of the positioning information of the terminal device, and the second information is used to determine the interval between every two moments in the I moments.

According to a sixth aspect, the apparatus may be configured to perform the method in the third aspect. The apparatus may be a terminal device, or the apparatus may be a component (for example, a chip, a chip system, or a circuit) in the terminal device, or may be an apparatus that can be used in a matching manner with the terminal device.

In an embodiment, the communication apparatus may include modules or units that perform the corresponding method/operations/steps/actions described in the third aspect. The module or unit may be implemented by a hardware circuit, software, or a combination of the hardware circuit and the software. In an embodiment, the apparatus may include a processing unit (which may also be referred to as a processing module) and a communication unit (which may also be referred to as a communication module). The communication unit may be configured to perform a receiving and/or sending function, and the processing unit may be configured to perform the method in the third aspect or any possible implementation of the third aspect.

An example in which the communication apparatus includes a communication module and a processing module is used. For functions of the modules, refer to the following understanding.

The processing module is configured to: when determining to update a first parameter, send second information to a serving satellite by using a communication module, where the second information is used to request configuration information of a random access sequence, and the first parameter includes one or more pieces of the following information: positioning information of a terminal device, ephemeris information of the serving satellite, and common timing advance TA information.

The processing module is further configured to send the random access sequence based on received configuration information of the random access sequence by using the communication module. The terminal device receives a third timing advance command TAC, and determines a TA adjustment value based on the third TAC, where the third TAC is a 1^{st} TAC received by the terminal device after the terminal device sends the random access sequence.

The communication module is further configured to communicate with the serving satellite based on the TA adjustment value.

In an embodiment, the TA adjustment value T_{TA} satisfies the following relational expression:

T_{TA}=(N_{TA}+N_{TA,UE-specific}+N_{TA,common}+N_{TA,offset})×T_{c}

$${N}_{TA} = ( {T}_{A} - 31 ) \times \frac{16.64}{{2}^{μ}} ,$$

T_{A} is a timing advance determined based on the third TAC, and μ is a coefficient determined based on a subcarrier spacing corresponding to the terminal device; and N_{TA,UE-specific} is a timing advance determined based on the ephemeris information of the serving satellite and the positioning information of the terminal device, N_{TA,common} is a timing advance associated with the common TA information, N_{TA,offset} is a preconfigured timing offset, and T_{c} is a minimum time unit.

According to a seventh aspect, this disclosure provides a communication apparatus that includes at least one processor and a memory. The memory is configured to store a computer program or instructions. When the apparatus is run, the at least one processor executes the computer program or the instructions, to enable the communication apparatus to perform the method according to the first aspect or any embodiment of the first aspect, or perform the method according to the second aspect or any embodiment of the second aspect, or perform the method according to the third aspect or any embodiment of the third aspect.

According to an eighth aspect, this disclosure provides another communication apparatus that includes a logic circuit and an input/output interface, where the input/output interface may be understood as an interface circuit, and the logic circuit may be configured to run code instructions to perform the method in the first aspect or any embodiment of the first aspect, or perform the method in the second aspect or any embodiment of the second aspect, or perform the method in the third aspect or any embodiment of the third aspect.

According to a ninth aspect, this disclosure further provides a computer-readable storage medium. The computer-readable storage medium stores computer readable instructions. When the computer readable instructions are run on a computer, the computer is enabled to perform the method according to the first aspect or any possible design of the first aspect, or perform the method according to the second aspect or any possible design of the second aspect, or perform the method according to the third aspect or any embodiment of the third aspect.

According to a tenth aspect, this disclosure provides a computer program product that includes instructions. When the computer program product is run on a computer, the computer is enabled to perform the method in the first aspect or any embodiment of the first aspect, or perform the method in the second aspect or any embodiment of the second aspect, or perform the method in the third aspect or any embodiment of the third aspect.

According to an eleventh aspect, this disclosure provides a chip system. The chip system includes a processor, may further include a memory, and is configured to implement the method in the first aspect or any possible design of the first aspect, or perform the method in the second aspect or any possible design of the second aspect, or perform the method in the third aspect or any possible design of the third aspect. The chip system may include a chip, or may include a chip and another discrete component.

According to a twelfth aspect, this disclosure provides a communication system. The system includes a terminal device and a satellite, and the communication system is configured to perform the method in the first aspect or any possible design of the first aspect, or perform the method in the second aspect or any possible design of the second aspect, or perform the method in the third aspect or any possible design of the third aspect.

For technical effect that can be achieved in the fourth aspect to the twelfth aspect, refer to descriptions of technical effect that can be achieved by corresponding possible design solutions of the first aspect or the second aspect. Details are not described herein again in this disclosure.

### BRIEF DESCRIPTION OF DRAWINGS

FIG. 1 is a diagram of a terrestrial communication system;

FIG. 2 is a diagram of a non-terrestrial communication system according to an embodiment of this disclosure;

FIG. 3 is a diagram of an architecture of a 5th generation (5G) satellite communication system according to an embodiment of this disclosure;

FIG. 4 to FIG. 7 are schematic flowcharts of several TA determining methods according to an embodiment of this disclosure;

FIG. 8 is a diagram of a structure of a communication apparatus according to an embodiment of this disclosure; and

FIG. 9 is a diagram of a structure of another communication apparatus according to an embodiment of this disclosure.

### DESCRIPTION OF EMBODIMENTS

To make objectives, technical solutions, and advantages of embodiments of this disclosure clearer, the following further describes embodiments of this disclosure in detail with reference to the accompanying drawings.

At least one piece (item) in embodiments of this disclosure indicates one or more pieces (items). The term “a plurality of pieces (items)” means two pieces (items) or more pieces (items). The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects. In addition, it should be understood that, although terms such as first and second may be used in embodiments of this disclosure to describe objects, these objects should not be limited by these terms. The terms are merely used for distinguishing the objects from each other.

The terms “include”, “have”, and any variants thereof in the following descriptions of embodiments of this disclosure are intended to cover a non-exclusive inclusion. For example, a process, a method, a system, a product, or a device that includes a series of operations or units is not limited to the listed operations or units, but optionally further includes other unlisted operations or units, or optionally further includes another inherent operation or unit of the process, the method, the product, or the device. It should be noted that, in embodiments of this disclosure, the word “exemplary” or “for example” is used to represent giving an example, an illustration, or a description. Any method or design solution described as an “example” or “for example” in embodiments of this disclosure should not be explained as being more preferred or having more advantages than another method or design solution. Exactly, use of the term “example”, “for example”, or the like is intended to present a related concept in a manner.

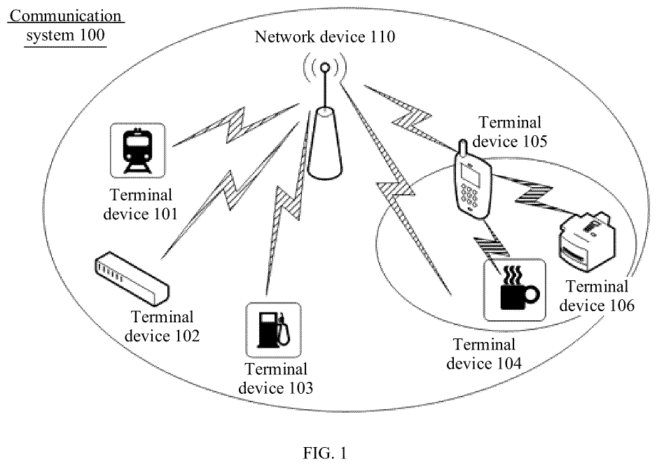

FIG. 1 shows an architecture of a terrestrial network communication system. The communication system 100 may include a network device 110 and terminal devices 101 to 106. It should be understood that the communication system 100 may include more or fewer network devices or terminal devices. The network device or the terminal device may be hardware, or may be software obtained through function division, or may be a combination thereof. In addition, the terminal devices 104 to 106 may alternatively form a communication system. For example, the terminal device 105 may send downlink data to the terminal device 104 or the terminal device 106. The network device and the terminal device may communicate with each other through another device or network element. The network device 110 may send downlink data to the terminal devices 101 to 106, or may receive uplink data sent by the terminal devices 101 to 106. Certainly, the terminal devices 101 to 106 may also send uplink data to the network device 110, or may receive downlink data sent by the network device 110.

The network device 110 is a node in a radio access network (RAN), and may also be referred to as a base station or a RAN node (or device). Currently, some examples of the access network device are a gNB/NR-NB, a transmission reception point (TRP), an evolved NodeB (eNB), a radio network controller (RNC), a NodeB (NB), a base station controller (base station controller, BSC), a base transceiver station (BTS), a home base station (for example, a home evolved NodeB or a home NodeB, HNB), a baseband unit (BBU), a wireless fidelity (Wi-Fi) access point (AP), a network device in a 5G communication system, and a network device in a future possible communication system. Alternatively, the network device 110 may be another device having a network device function. For example, the network device 110 may be a device implementing a network device function in D2D communication. The network device 110 may alternatively be a network device in a future possible communication system.

The terminal devices 101 to 106 may also be referred to as UE devices, mobile stations (MSs), mobile terminals (MTs), or the like, and are devices that provide voice or data connectivity for users; or may be internet of things devices. For example, the terminal devices 101 to 106 include a handheld device, a vehicle-mounted device, and the like that have a wireless connection function. Currently, the terminal devices 101 to 106 each may be a mobile phone, a tablet computer, a notebook computer, a palmtop computer, a mobile internet device (MID), a wearable device (for example, a smartwatch, a smart band, or a pedometer), a vehicle-mounted device (for example, an automobile, a bicycle, an electric vehicle, an aircraft, a ship, a train, or a high-speed train), a virtual reality (VR) device, an augmented reality (AR) device, a wireless terminal in industrial control (industrial control), a smart home device (for example, a refrigerator, a television, an air conditioner, or an electricity meter), an intelligent robot, a workshop device, a wireless terminal in self driving, a wireless terminal in remote medical surgery, a wireless terminal in a smart grid, a wireless terminal in transportation safety, a wireless terminal in a smart city, a wireless terminal in a smart home, a flight device (for example, an intelligent robot, a hot balloon, an uncrewed aerial vehicle, or an aircraft), or the like. The terminal devices 101 to 106 may alternatively be other devices that have a terminal function. For example, the terminal devices 101 to 106 may alternatively be devices that function as terminals in D2D communication.

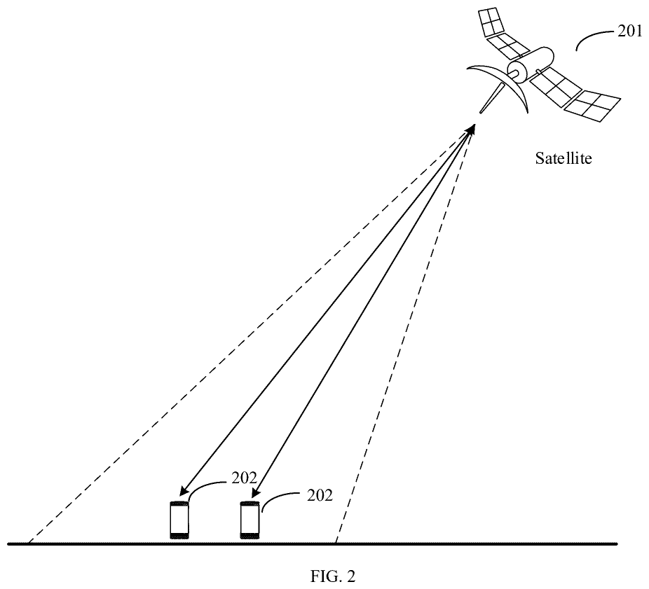

Based on the description of the architecture of the terrestrial network communication system shown in FIG. 1, a TA determining method provided in embodiments of this disclosure may be applied to a non-terrestrial network (NTN) communication system. As shown in FIG. 2, the NTN communication system includes a satellite 201 and a terminal device 202. For explanation of the terminal device 202, refer to the related descriptions of the terminal devices 101 to 106. The satellite 201 may also be referred to as a high-altitude platform, a high-altitude aircraft, or a satellite base station. If the NTN communication system is compared with the terrestrial network communication system, the satellite 201 may be considered as one or more network devices in the architecture of the terrestrial network communication system. The satellite 201 provides a communication service to the terminal device 202, and the satellite 201 may be further connected to a core network device. For a structure and a function of the satellite, refer to the foregoing description of the network device. For a communication manner between the satellite 201 and the terminal device 202, refer to the descriptions in FIG. 1. Details are not described herein again.

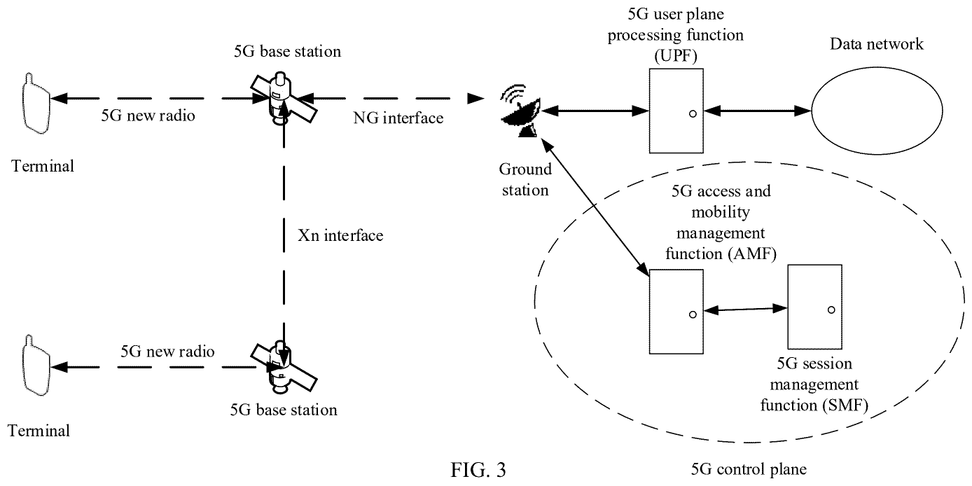

5G is used as an example. An architecture of a 5G satellite communication system is shown in FIG. 3. A terrestrial terminal device accesses a network through 5G new radio. A 5G base station is deployed on the satellite, and is connected to a terrestrial core network through a radio link. In addition, there is a radio link between satellites, to complete signaling interaction and user data transmission between base stations. Devices and interfaces in FIG. 3 are described as follows:

5G core network: provides services such as user access control, mobility management, session management, user security authentication, and charging. The 5G core network includes a plurality of functional units, and may be divided into a control plane functional entity and a data plane functional entity. An access and mobility management unit (AMF) is responsible for user access management, security authentication, and mobility management. A user plane unit (UPF) is responsible for functions such as managing user plane data transmission and traffic statistics.

Ground station: is responsible for forwarding signaling and service data between a satellite base station and the 5G core network.
5G new radio: is a radio link between a terminal and a base station.
Xn interface: is an interface between a 5G base station and a base station, and is mainly used for signaling interaction, for example, handover.
NG interface: is an interface between a 5G base station and a 5G core network, and is mainly used for exchange of user service data and signaling such as NAS of the core network.

The network device in the terrestrial network communication system and the satellite in the NTN communication system may be collectively considered as network devices. An apparatus configured to implement a function of the network device may be a network device or may be an apparatus that can support the network device in implementing the function, for example, a chip system. The apparatus may be installed in the network device. When the technical solutions provided in embodiments of this disclosure are described below, an example in which an apparatus configured to implement a function of a network device is a satellite is used to describe the technical solutions provided in embodiments of this disclosure. It may be understood that, when the method provided in embodiments of this disclosure is applied to the terrestrial network communication system, an action performed by the satellite may be performed by a base station or a network device.

In embodiments of this disclosure, an apparatus configured to implement a function of a terminal device may be a terminal device, or may be an apparatus, for example, a chip system, that can support the terminal device in implementing the function. The apparatus may be installed in the terminal device. In this embodiment of this disclosure, the chip system may include a chip, or may include a chip and another discrete component. In the technical solutions provided in embodiments of this disclosure, an example in which the apparatus configured to implement a function of a terminal device is a terminal or a UE device is used to describe the technical solutions provided in embodiments of this disclosure.

In addition, the satellite may be a geostationary satellite, a non-geostationary satellite, an artificial satellite, a low earth orbit satellite, a medium earth orbit satellite, a high earth orbit satellite, or the like. This is not limited herein in this disclosure.

As described in the background, in the related technology, a TA adjustment value T_{TA} used for communication between a terminal device and a serving satellite may be determined according to the following relational expression (1):

T_{TA}=(N_{TA}+N_{TA,UE-specific}+N_{TA,common}+N_{TA,offset})×T_{c} (1)

(a) N_{TA}: When the terminal device sends a random access sequence, or sends a physical random access channel (PRACH), N_{TA}=0. For example, in a non-contention-based random access process, the serving satellite may use control signaling to indicate configuration information of the random access sequence, for example, a random access resource. In an embodiment, the control signaling may be a physical downlink control channel (PDCCH). Because the PDCCH indicates the configuration information of the random access sequence, the PDCCH may also be denoted as a PDCCH ordered PRACH. The terminal device sends the random access sequence based on the random access resource indicated by the control signaling. In this case, N_{TA}=0.

Further, after sending the random access sequence, the terminal device receives a random access response (RAR) message from the serving satellite, where the RAR message includes a TAC. The terminal device may update N_{TA} based on a TA corresponding to the TAC. Subsequently, after each reception of a TAC, the terminal accumulates a TA corresponding to a historical TAC to determine a new N_{TA}, denoted as N_{TA_new}. In other words, it may be understood that, when there is an accumulated TA corresponding to a historical TAC, N_{TA} in the relational expression (1) may be replaced with N_{TA_new}. N_{TA_new} satisfies the following relational expression (2):

$${N}_{TA \_ new} = {N}_{TA \_ old} + ( {T}_{A} - 31 ) \cdot \frac{16.64}{{2}^{μ}} \qquad ( 2 )$$

T_{A} may be understood as a timing advance determined based on a latest received TAC; N_{TA_old} may be understood as a value of N_{TA} when the TA adjustment value is determined last time; and μ is a coefficient determined based on a subcarrier spacing corresponding to the terminal device, for example, p may be a scaling factor of the subcarrier spacing relative to a reference subcarrier spacing. In addition, N_{TA} or N_{TA_new} may be understood as a TA corresponding to a closed-loop TA adjustment mechanism.

(b) N_{TA,UE-specific} is a timing advance determined based on ephemeris information of the serving satellite and positioning information of the terminal device. For example, N_{TA,UE-specific} is a round-trip transmission delay from the terminal device to the serving satellite, or is referred to as a round-trip transmission delay of a service link. In addition, it may be understood that updates of the ephemeris information of the serving satellite and the positioning information of the terminal device are sent in some communication scenarios, and the ephemeris information of the serving satellite and the positioning information of the terminal device that are currently latest are substituted during calculation of T_{TA}. In an embodiment, the positioning information of the terminal device may be GNSS information of the terminal device, and the terminal device may update the GNSS information. Updated ephemeris information of the serving satellite may be indicated to the terminal device by the serving satellite in a broadcast manner.

(c) N_{TA,common} is a timing advance associated with a common TA.

The common TA is a round-trip transmission delay from a satellite to a reference point. The reference point may be located at the satellite, a ground station, or another location, for example, a location on a service link from the satellite to the terminal device, or a location on a feed circuit from the satellite to the ground station. This is not limited in this embodiment of this disclosure. “N_{TA,UE-specific}+N_{TA,common}” may be understood as a TA corresponding to an open-loop TA adjustment mechanism.

In an embodiment, the serving satellite may broadcast the common TA or a parameter used to determine the common TA. The terminal device determines the common TA based on a received broadcast message, and determines N_{TA,common} based on the common TA and T_{c}. T_{c} is a minimum time unit. T_{c} may be predefined, or may be determined by the terminal device through negotiation with an access network device, or may be configured by the access network device for the terminal device.

For example, to prevent the terminal device from frequently monitoring a broadcast message, a parameter of the common TA usually includes one or more of the common TA, a TA change rate, and a high-order change rate such as a second-order TA change rate or a third-order TA change rate. The terminal device may perform estimation on the common TA within a time range based on these parameters.

(d) N_{TA,offset} is a preconfigured timing offset. For example, a value of N_{TA,offset} is related to a communication mode of the terminal device and the serving satellite, and the communication mode of the terminal device and the serving satellite may be time division duplex (TDD) or frequency division duplex (FDD).

It may be understood that the foregoing relational expressions (1) and (2) are used as an example of determining the TA adjustment value. In actual disclosure, the relational expression may be properly adjusted, for example, some parameters in the relational expression are modified. This is not limited in this embodiment of this disclosure.

The foregoing TA adjustment mechanism is applied to satellite communication. After the terminal receives the TAC, N_{TA_old} is accumulated to the TA adjustment value determined by the terminal device, to compensate for an error of the ephemeris information, the common TA information, or the positioning information. When performing location update or ephemeris update, the terminal may compensate for the error of the ephemeris information, the common TA information, or the positioning information. The two types of error compensation are performed at the same time. As a result, there are more errors of the ephemeris information, the common TA information, or the GNSS that is determined by the terminal, and a TA error jump is generated. Consequently, the determined TA adjustment value is inaccurate. An example is as follows:

At a moment T0, the terminal device monitors the ephemeris information or the common TA information, and updates the GNSS.

At a moment T1, the terminal device initiates an uplink signal to a network side (for example, the serving satellite).

At a moment T2, the terminal device receives the TAC and adjusts the TA adjustment value based on the TAC. The TAC is determined after the network side performs estimation on the uplink signal initiated by the terminal at the moment T1, and the TAC may represent error compensation for the GNSS, the ephemeris information, or the common TA information at the moment T1.

At a moment T3, the terminal device compensates for errors of these parameters through updates of the ephemeris information, the GNSS, or the common TA information. However, accumulated N_{TA_old} still exists when the TAC is received previously. As a result, the determined TA adjustment value is inaccurate.

Considering the foregoing case, this disclosure provides a TA determining method, to reduce an error jump during determining of a TA adjustment value is determined, and ensure accuracy of the TA adjustment value. The following further provides detailed descriptions with reference to the accompanying drawings.

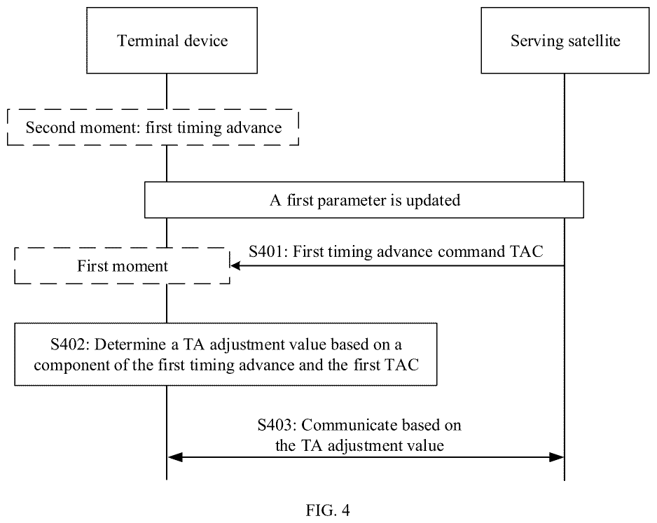

FIG. 4 shows a first TA determining method. The method mainly includes the following procedures.

S401: A serving satellite sends a first timing advance command TAC to a terminal device, and the terminal device receives the first TAC at a first moment.

The terminal device receives at least one TAC before receiving the first TAC. A moment at which the terminal device receives a TAC previous to the first TAC is denoted as a second moment, and a time period between the second moment and the first moment is denoted as a first time period.

If one or more pieces of information of positioning information of the terminal device, ephemeris information of the serving satellite, and a common timing advance TA are updated in the first time period, that the terminal device determines a TA adjustment value based on the first TAC may be performed with reference to S402. If one or more pieces of information of the positioning information of the terminal device, the ephemeris information of the serving satellite, and the common timing advance TA are not updated in the first time period, the TA adjustment value is determined according to the relational expressions (1) and (2).

S402: The terminal device determines the TA adjustment value based on a component of a first timing advance and the first TAC.

The first timing advance is determined by the terminal device at the second moment. For example, the terminal device may determine the first timing advance at the second moment according to the foregoing relational expression (2). At the second moment, N_{TA_new} in the relational expression (2) indicates the first timing advance. The first timing advance is determined based on N_{TA_old} before the second moment and a TA corresponding to a TAC received at the second moment. The component of the first timing advance may be zero, or a percentage of the component of the first timing advance in the first timing advance is less than 100%, for example, is preconfigured to be 40% or another value.

In an embodiment, the terminal device may determine the TA adjustment value according to the following relational expressions (3) and (4).

T_{TA}=(N_{TA_new}+N_{TA,UE-specific}+N_{TA,common}+N_{TA,offset})×T_{c} (3)

N_{TA,UE-specific}, N_{TA,common}, N_{TA,offset}, and T_{c} may be understood with reference to the explanation in the relational expression (1). Details are not described in this embodiment of this disclosure. N_{TA_new} may be understood as N_{TA} determined by the terminal device at the first moment, and N_{TA_new} satisfies the following relational expression (4):

$${N}_{TA \_ new} = α \times {N}_{TA \_ old} + ( {T}_{A} - 31 ) \times \frac{16.64}{{2}^{μ}} \qquad ( 4 )$$

N_{TA_old} is the first timing advance, α×N_{TA_old} represents the component of the first timing advance, 0≤α<1, T_{A} is a timing advance determined based on the first TAC, and μ is a coefficient determined based on a subcarrier spacing corresponding to the terminal device. In an embodiment, when α is equal to 0, the relational expression (4) may be replaced with

$${N}_{TA \_ new} = 0 + ( {T}_{A} - 31 ) \times \frac{16.64}{{2}^{μ}} or {N}_{TA \_ new} = ( {T}_{A} - 31 ) \times \frac{16.64}{{2}^{μ}} .$$

In an embodiment, when α is equal to 0, S402 may also be understood as that the terminal device determines the TA adjustment value based on the first TAC, and the first timing advance is not considered during determining of the TA adjustment value based on the first TAC, where N_{TA_old}=0.

For ease of description, in this embodiment of this disclosure, the first parameter indicates information updated in the first time period. In FIG. 4, before S401, it is shown that the first parameter is updated in the first time period. Alternatively, it may be understood that the first parameter includes one or more pieces of information of the positioning information of the terminal device, the ephemeris information of the serving satellite, and the common timing advance TA.

In an embodiment, in different communication scenarios, content included in the first parameter may be different. Examples of some scenarios are as follows.
Scenario 1: In a scenario in which the serving satellite is a geostationary earth orbit (GEO) satellite, error compensation corresponding to an update of the positioning information of the terminal device is mainly included. Therefore, the first parameter may include only the positioning information of the terminal device. In an embodiment, when receiving a 1^{st} TAC after updating the positioning information, the terminal device may determine the TA adjustment value in the manner in S402.
Scenario 2: In a scenario in which the serving satellite is a low earth orbit (low earth orbit, LEO) satellite and the terminal device is in a stationary state, error compensation for an update of the ephemeris information of the serving satellite is mainly included. Therefore, the first parameter may include only the ephemeris information of the terminal device. In an embodiment, when receiving a 1^{st} TAC after obtaining updated ephemeris information of the serving satellite, the terminal device may determine the TA adjustment value in the manner in S402.
Scenario 3: In a scenario in which the serving satellite is a low earth orbit LEO satellite and the terminal device is in a moving state, error compensation for updates of the ephemeris information of the serving satellite and the positioning information of the terminal device may be included. The terminal device may determine, based on a parameter related to the positioning information (for example, a moving speed, a moving range, positioning precision, and a positioning error of the terminal device) and obtained ephemeris information of the serving satellite (for example, an orbital altitude of the serving satellite, precision information of the ephemeris, validity time of the ephemeris, and an error of the ephemeris), that the first parameter includes one or more of the ephemeris information of the serving satellite and the positioning information of the terminal device. Some examples are as follows.

Example 1: When the moving speed of the terminal device is greater than a first speed threshold, or a precision of estimating the positioning information by the terminal device is less than a first precision threshold, the first parameter includes the positioning information of the terminal device and the ephemeris information of the serving satellite. The first speed threshold may be predefined or preconfigured, or the serving satellite indicates the first speed threshold to the terminal device. The first precision threshold may be predefined or preconfigured, or the serving satellite indicates the first precision threshold to the terminal device. In an embodiment, when receiving a 1^{st} TAC after obtaining the updated ephemeris information of the serving satellite and the updated positioning information, the terminal device may determine the TA adjustment value in the manner in S402.

Example 2: When the moving speed of the terminal device is less than a second speed threshold, or the precision of estimating the positioning information by the terminal device is greater than a second precision threshold, it indicates that error compensation for an update of the positioning information of the terminal device is small. In this case, the first parameter may include only the ephemeris information of the serving satellite. The second speed threshold may be predefined or preconfigured, or the serving satellite indicates the first speed threshold to the terminal device. The second speed threshold is less than or equal to the first speed threshold. The second precision threshold may be predefined or preconfigured, or the serving satellite indicates the first precision threshold to the terminal device. The second precision threshold is greater than or equal to the first precision threshold. In an embodiment, when receiving a 1^{st} TAC after obtaining the updated ephemeris information of the serving satellite, the terminal device may determine the TA adjustment value in the manner in S402.

Example 3: When the orbital altitude of the serving satellite is less than a first altitude threshold, the first parameter includes the ephemeris information of the serving satellite. The first altitude threshold may be predefined or preconfigured, or the serving satellite indicates the first altitude threshold to the terminal device. In an embodiment, when receiving a 1^{st} TAC after obtaining the updated ephemeris information of the serving satellite, the terminal device may determine the TA adjustment value in the manner in S402.

Example 4: When the orbital altitude of the serving satellite is greater than a second altitude threshold, the first parameter includes the positioning information of the terminal device. The second altitude threshold may be predefined or preconfigured, or the serving satellite indicates the second altitude threshold to the terminal device. The second altitude threshold is greater than or equal to the first altitude threshold. In an embodiment, when receiving a 1^{st} TAC after updating the positioning information, the terminal device may determine the TA adjustment value in the manner in S402.

Example 5: When the moving speed of the terminal device is greater than the first speed threshold, and the orbital altitude of the serving satellite is greater than the second altitude threshold, the first parameter includes the positioning information of the terminal device. In an embodiment, when receiving a 1^{st} TAC after updating the positioning information, the terminal device may determine the TA adjustment value in the manner in S402.

Example 6: When the moving speed of the terminal device is less than the second speed threshold, and the orbital altitude of the serving satellite is less than the first altitude threshold, the first parameter includes the ephemeris information of the serving satellite. In an embodiment, when receiving a 1^{st} TAC after obtaining the updated ephemeris information of the serving satellite, the terminal device may determine the TA adjustment value in the manner in S402.

Example 7: When an error corresponding to the ephemeris information of the serving satellite is less than a first error threshold, the first parameter includes the positioning information of the terminal device. In an embodiment, the first error threshold may be predefined or preconfigured, or the serving satellite indicates the first error threshold to the terminal device. In an embodiment, when receiving a 1^{st} TAC after updating the positioning information, the terminal device may determine the TA adjustment value in the manner in S402.

The error corresponding to the ephemeris information mainly includes an initial error of the ephemeris indicated by the serving satellite and a derivation error of deriving the ephemeris by the terminal device. In an embodiment, precision of ephemeris derivation on a terminal device side is high, so that a derivation error of ephemeris derivation is small, and an error corresponding to the ephemeris information may be less than the first error threshold. In an embodiment, the terminal device may further report, to the serving satellite, precision of ephemeris derivation or an error model used to determine the derivation error. The serving satellite may configure validity time or an update periodicity of the ephemeris information for the terminal device based on information reported by the terminal device. In this case, the terminal device may determine, based on the validity time or the update periodicity of the ephemeris information, time for reading the ephemeris information broadcast by the serving satellite, to reduce impact of reading the ephemeris information or updating the positioning information by the terminal device on determining the TA adjustment value.

Example 8: When the error corresponding to the positioning information of the terminal device is less than the second error threshold, the first parameter includes the ephemeris information of the terminal device. In an embodiment, the second error threshold may be predefined or preconfigured, or the serving satellite indicates the second error threshold to the terminal device. In an embodiment, when receiving a 1^{st} TAC after obtaining the updated ephemeris information of the serving satellite, the terminal device may determine the TA adjustment value in the manner in S402.

The terminal device may determine the precision and the error of the positioning information. In an embodiment, the terminal device may further report the error (which may be a value or an error range) corresponding to the positioning information to the serving satellite.

Further, the terminal device may further perform S403.

S403: The terminal device communicates with the serving satellite based on the TA adjustment value.

In an embodiment, the TA adjustment value corresponds to the first TAC received by the terminal device in S401. The terminal device may communicate with the serving satellite based on the TA adjustment value until the TA adjustment value is updated after a next TAC is received.

According to the foregoing method provided in this embodiment of this disclosure, in a satellite communication scenario, an update of the positioning information of the terminal device and/or an update of the ephemeris of the serving satellite are/is used as a trigger condition, to reduce error compensation in a closed-loop TA adjustment mechanism, so that an error jump during determining of the TA adjustment value can be reduced, and accuracy of the TA adjustment value can be ensured.

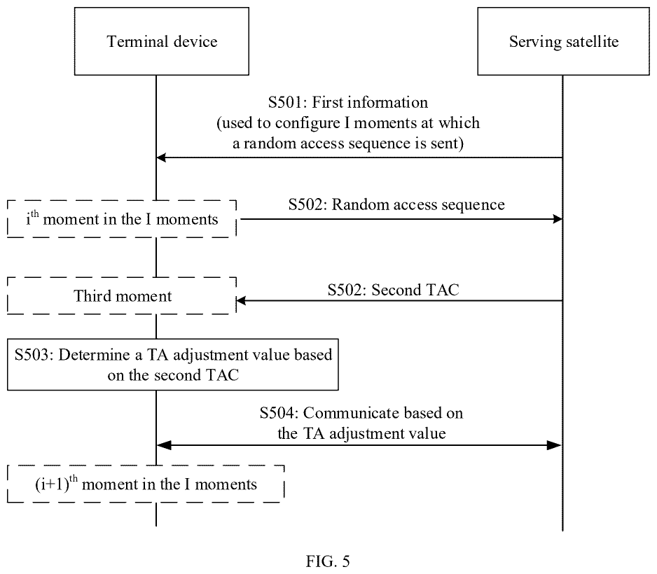

FIG. 5 shows a second TA determining method. The method mainly includes the following procedures.

S501: A serving satellite sends first information to a terminal device.

The first information indicates periodicity information of sending a random access sequence by the terminal device. For example, the first information indicates I moments at which the terminal device sends the random access sequence, an interval between every two moments in the I moments are the same, and I is a positive integer greater than 1.

In an embodiment, the terminal device may report validity time of positioning information to the serving satellite, and the serving satellite configures the periodicity information of the random access sequence based on the validity time of the positioning information of the terminal device. For example, the interval between every two moments in the I moments is less than or equal to the validity time of the positioning information of the terminal device.

S502: The terminal device sends the random access sequence at an i^{th} moment in the I moments, and receives a second timing advance command TAC from the serving satellite at a third moment.

The third moment is a moment between the i^{th} moment and an (i+1)^{th} moment, and i is a positive integer ranging from 1 to I−1. In an embodiment, the second TAC is a 1^{st} TAC received by the terminal device after the i^{th} moment.

In addition, it may be understood that the serving satellite may periodically send a PDCCH (for example, a PDCCH order PARCH) to trigger the terminal device to send the random access sequence. For example, the serving satellite sends a PDCCH order PARCH in a time period between an (i−1)^{th} moment and the i^{th} moment, so that the terminal device can be triggered to send the random access sequence at the i^{th} moment.

S503: The terminal device determines a TA adjustment value based on the second TAC.

Corresponding to the description in the formula (1), it may be understood that N_{TA} returns to zero when the terminal device sends the random access sequence at the i^{th} moment. Therefore, when determining the TA adjustment value after receiving the second TAC, the terminal device does not accumulate a TA corresponding to a historical TAC.

In an embodiment, the TA adjustment value T_{TA} determined by the terminal device based on the second TAC satisfies the following relational expressions (5) and (6):

T_{TA}=(N_{TA}+N_{TA,UE-specific}+N_{TA,common}+N_{TA,offset})×T_{c} (5)

N_{TA,UE-specific}, N_{TA,common}, N_{TA,offset}, and T_{c} may be understood with reference to the explanation in the relational expression (1). Details are not described in this embodiment of this disclosure. N_{TA} is a timing advance determined by the terminal device based on the second TAC, and N_{TA} satisfies the following relational expression (6):

$${N}_{TA} = ( {T}_{A} - 31 ) \times \frac{16.64}{{2}^{μ}} \qquad ( 6 )$$

μ is a coefficient determined based on a subcarrier spacing corresponding to the terminal device.

S504: The terminal device communicates with the serving satellite based on the TA adjustment value.

In an embodiment, the TA adjustment value corresponds to the second TAC received by the terminal device in S502. The terminal device may communicate with the serving satellite based on the TA adjustment value until the TA adjustment value is updated after a next TAC of the second TAC is received.

According to the foregoing method provided in this embodiment of this disclosure, a feature that N_{TA} accumulated based on a historical TAC returns to zero when the terminal device sends the random access sequence is used to configure periodic sending of the random access sequence, to periodically reduce error compensation in a closed-loop TA adjustment mechanism for a plurality of times, so that an error jump during determining of the TA adjustment value can be reduced, and accuracy of the TA adjustment value can be ensured. For example, in a communication scenario of a GEO satellite, a TA is mainly caused by an error of the positioning information (GNSS information) of the terminal device. The serving satellite configures a sufficient quantity of PDCCH ordered PRACHs based on validity time of the positioning information of the terminal device, to correct an accumulated TA error of the TAC. In an LEO scenario, the TA error is mainly caused by an initial error of ephemeris of the serving satellite, and the serving satellite may send a sufficient quantity of PDCCH order PRACHs to correct the accumulated TA error of the TAC.

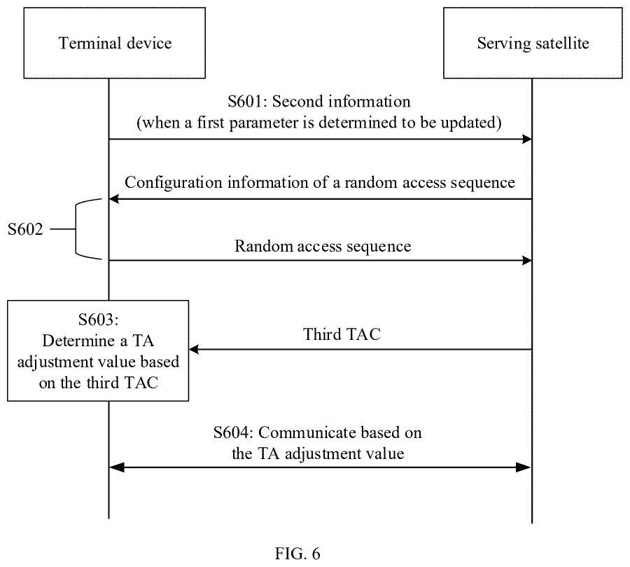

FIG. 6 shows a third TA determining method. The method includes the following procedures.

S601: When determining to update a first parameter, a terminal device sends second information to a serving satellite.

The first parameter may be one or more pieces of the following information: positioning information of the terminal device, ephemeris information of the serving satellite, and common timing advance TA information. The second information is used to request configuration information of a random access sequence. For example, the second information is used to request the serving satellite to send a PDCCH order PRACH.

In an embodiment, the second information sent by the terminal device may be an uplink (uplink, UL)-media access control (MAC)-control element (CE) signaling, which is referred to as a UL MAC CE for short. The terminal device may further make an update operation take effect on the first parameter by using the UL MAC CE. In other words, the terminal device may update the first parameter after sending the UL MAC CE. In such a design, the serving satellite performs PRACH configuration only upon a request from the terminal device, so that a PDCCH/PRACH resource can be saved.

Correspondingly, if the terminal device receives the configuration information of the random access sequence, for example, the PDCCH order PRACH, the terminal device sends the random access sequence to the serving satellite, that is, the terminal device performs S602 after S601. If the terminal device does not receive the configuration information of the random access sequence, for example, the PDCCH order PRACH, the terminal device does not send the random access sequence to the serving satellite.

S602: The terminal device receives the configuration information of the random access sequence, and sends the random access sequence.

Correspondingly, after receiving the random access sequence, the serving satellite sends a TAC to the terminal device by using a RAR message, and the TAC is denoted as a third TAC. For the terminal device, the third TAC is a 1^{st} TAC received by the terminal device after the terminal device sends the random access sequence. In an embodiment, the terminal device may perform the following operation S603 after performing S602.

S603: The terminal device receives the third TAC, and determines a TA adjustment value based on the third TAC.

Corresponding to the description in the formula (1), it may be understood that N_{TA} returns to zero when the terminal device sends the random access sequence. Therefore, when determining the TA adjustment value after receiving the third TAC, the terminal device does not accumulate a TA corresponding to a historical TAC.

In an embodiment, the terminal device may determine the TA adjustment value T_{TA} based on the third TAC according to the relational expressions (5) and (6). It may be understood that the timing advance corresponding to the third TAC is substituted into T_{A} in the relational expression (6) in S603. In an embodiment, the terminal device determines N_{TA} in the relational expression (5) based on the relational expression (6) and a timing advance T_{A} corresponding to the third TAC, to determine the TA adjustment value according to the relational expression (5).

Further, after performing S603, the terminal device may further perform operation S604.

S604: The terminal device communicates with the serving satellite based on the TA adjustment value.

In an embodiment, the TA adjustment value corresponds to the third TAC received by the terminal device in S603. The terminal device may communicate with the serving satellite based on the TA adjustment value until the TA adjustment value is updated after a next TAC of the third TAC is received.

According to the foregoing method provided in this embodiment of this disclosure, the terminal device uses a feature that corresponding N_{TA} accumulated based on a historical TAC returns to zero when the random access sequence is sent to request a network side to send the random access sequence in an update process of the positioning information or the ephemeris information, to reduce error compensation in a closed-loop TA adjustment mechanism, so that an error jump during determining of the TA adjustment value can be reduced, and accuracy of the TA adjustment value can be ensured.

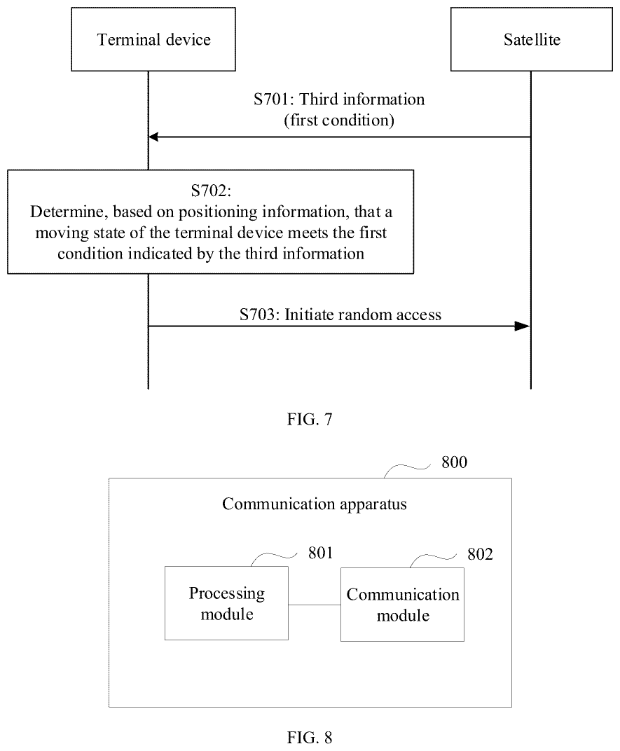

FIG. 7 shows a fourth TA determining method. The method is mainly applied to a communication scenario in which a terminal device is in a moving state. The method includes the following procedures.

S701: A satellite sends third information to a terminal device.

The third information indicates a requirement for the moving state of the terminal device. For example, the third information indicates a first condition that needs to be met by the moving state of the terminal device. In an embodiment, the satellite may send the third information in a broadcast manner, and the terminal device obtains the third information by monitoring a broadcast message. The satellite may be an LEO satellite or a GEO satellite.

In an embodiment, the moving state of the terminal device may include parameters such as a moving speed of the terminal device, a moving range of the terminal device in a unit of time, and a moving direction of the terminal device.

In a first possible implementation, the first condition indicated by the third information is that the moving speed of the terminal device is less than or equal to a third speed threshold, and the third information may include the third speed threshold. For example, the satellite may determine, based on an orbital altitude, an upper limit of the moving speed of the terminal device supported by the current satellite, that is, determine the third speed threshold. For another example, the satellite may determine the third speed threshold based on the orbital altitude and information about an elevation angle from the terminal device to the satellite. It may be understood that different pieces of elevation angle information correspond to different values of the third speed threshold.

In a second possible implementation, the first condition indicated by the third information is that the moving speed of the terminal device is in a first speed range, and the third information may include the first speed range. For example, the satellite may determine, based on the orbital altitude, a moving speed range of the terminal device supported by the current satellite, that is, determine the first speed range. For another example, the satellite may determine the first speed range based on the orbital altitude and the information about the elevation angle from the terminal device to the satellite. It may be understood that different pieces of elevation angle information correspond to different values of the first speed range.

In a third possible implementation, the first condition indicated by the third information is that the moving range of the terminal device in a unit of time is less than or equal to a first moving range, and the third information may include the first moving range. For example, the satellite may determine, based on the orbital altitude, an upper limit of a moving range of the terminal device in a unit of time supported by the current satellite, that is, determine the first moving range. For another example, the satellite may determine the first moving range based on the orbital altitude and the information about the elevation angle from the terminal device to the satellite. It may be understood that different pieces of elevation angle information correspond to different values of the first moving range.

Correspondingly, after receiving the third information, the terminal device may determine, based on positioning information, whether the moving state of the terminal device meets the first condition indicated by the third information. If the moving state meets the first condition, the terminal device initiates random access to the satellite, and continues to maintain that the moving state in a communication process after the random access meets the first condition. If the moving state does not meet the first condition, the terminal device does not initiate the random access to the satellite. For example, in FIG. 7, a case in which the moving state meets the first condition is shown by using S702 and S703.

S702: The terminal device determines, based on the positioning information, that the moving state of the terminal device meets the first condition indicated by the third information.

S703: The terminal device initiates the random access to the satellite.

For example, the terminal device may send a random access sequence on a random access resource configured by the satellite, so that the satellite may return a RAR message that includes a TAC. The terminal device may determine, based on a solution described in the relational expression (1), a TA adjustment value used for communication with the satellite. Details are not described in this embodiment of this disclosure.

The foregoing method provided in this embodiment of this disclosure is applied to a communication scenario of a mobile terminal. The moving speed or the moving range of the terminal device is controlled, so that error compensation for an update of the positioning information is reduced, that is, error compensation in the open-loop TA adjustment mechanism is reduced. In this way, an error jump during determining of the TA adjustment value can be reduced, and accuracy of the TA adjustment value can be ensured.

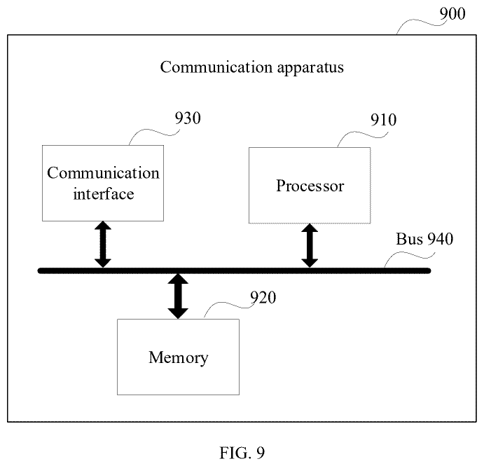

Based on a same concept, refer to FIG. 8. An embodiment of this disclosure provides a communication apparatus 800. The communication apparatus 800 includes a processing module 801 and a communication module 802. The communication apparatus 800 may be a terminal device, or may be a communication apparatus that is used in the terminal device or that is used in a matching manner with the terminal device and that can implement the communication method performed on a terminal device side. Alternatively, the communication apparatus 800 may be a network device (for example, a serving satellite of the terminal device), or may be a communication apparatus that is used in the network device or that is used in a matching manner with the network device and that can implement the communication method performed on a network device side.

The communication module may also be referred to as a transceiver module, a transceiver, a transceiver device, a transceiver apparatus, or the like. The processing module may also be referred to as a processor, a processing board, a processing unit, a processing apparatus, or the like. In an embodiment, the communication module is configured to perform a sending operation and a receiving operation of the terminal device side or the network device side in the foregoing method. A component configured to implement a receiving function in the communication module may be considered as a receiving unit, and a component configured to implement a sending function in the communication module may be considered as a sending unit. In other words, the communication module includes the receiving unit and the sending unit.

When the communication apparatus 800 is used in the terminal device, the processing module 801 may be configured to implement a processing function of the terminal device in embodiments shown in FIG. 4 to FIG. 7, and the communication module 802 may be configured to implement a receiving/sending function of the terminal device in embodiments shown in FIG. 4 to FIG. 7.

When the communication apparatus 800 is used in the network device, the processing module 801 may be configured to implement a processing function of the network device in embodiments shown in FIG. 4 to FIG. 7, and the communication module 802 may be configured to implement a receiving/sending function of the network device in embodiments shown in FIG. 4 to FIG. 7.

In addition, it should be noted that the communication module and/or the processing module may be implemented using a virtual module. For example, the processing module may be implemented using a software functional unit or a virtual apparatus, and the communication module may be implemented using a software functional or virtual apparatus. Alternatively, the processing module or the communication module may be implemented by a physical apparatus. For example, if the communication apparatus is implemented by a chip/chip circuit, the communication module may be an input/output circuit and/or a communication interface, and performs an input operation (corresponding to the foregoing receiving operation) and an output operation (corresponding to the foregoing sending operation). The processing module is an integrated processor, a microprocessor, or an integrated circuit.

Division into the modules in this embodiment of this disclosure is an example, is merely logical function division, and may be other division during actual implementation. In addition, functional modules in each of embodiments of this disclosure may be integrated into one processor, each of the modules may exist alone physically, or two or more modules may be integrated into one module. The integrated module may be implemented in a form of hardware, or may be implemented in a form of a software functional module.

Based on a same technical concept, an embodiment of this disclosure further provides a communication apparatus 900. For example, the communication apparatus 900 may be a chip or a chip system. For example, in embodiments of this disclosure, the chip system may include a chip, or may include a chip and another discrete component.

The communication apparatus 900 may be configured to implement a function of any network element in the communication system described in the foregoing embodiments. The communication apparatus 900 may include at least one processor 910. The processor 910 is coupled to a memory. In an embodiment, the memory may be located in the communication apparatus, the memory may be integrated with the processor, or the memory may be located outside the communication apparatus. For example, the communication apparatus 900 may further include at least one memory 920. The memory 920 stores a necessary computer program, a computer program, or instructions and/or data for implementing any one of the foregoing embodiments. The processor 910 may execute the computer program stored in the memory 920, to complete the method in any one of the foregoing embodiments.

The communication apparatus 900 may further include a communication interface 930. The communication apparatus 900 may exchange information with another device through the communication interface 930. For example, the communication interface 930 may be a transceiver, a circuit, a bus, a module, a pin, or a communication interface of another type. When the communication apparatus 900 is a chip-type apparatus or circuit, the communication interface 930 in the communication apparatus 900 may alternatively be an input/output circuit, and may input information (or referred to as receiving information) and output information (or referred to as sending information). The processor is an integrated processor, a microprocessor, an integrated circuit, or a logic circuit, and the processor may determine output information based on input information.

The coupling in this embodiment of this disclosure may be an indirect coupling or a communication connection between apparatuses, units, or modules in an electrical form, a mechanical form, or another form, and is used for information exchange between the apparatuses, the units, or the modules. The processor 910 may operate in collaboration with the memory 920 and the communication interface 930. In embodiments of this disclosure, a connection medium among the processor 910, the memory 920, and the communication interface 930 is not limited.

In an embodiment, refer to FIG. 9. The processor 910, the memory 920, and the communication interface 930 are connected to each other through a bus 940. The bus 940 may be a peripheral component interconnect (PCI) bus, an extended industry standard architecture (EISA) bus, or the like. The bus may be classified into an address bus, a data bus, a control bus, and the like. For ease of representation, only one thick line is used to represent the bus in FIG. 9, but this does not mean that there is only one bus or only one type of bus.

In embodiments of this disclosure, the processor may be a general-purpose processor, a digital signal processor, an application-specific integrated circuit, a field programmable gate array or another programmable logic device, a discrete gate or transistor logic device, or a discrete hardware component, and may implement or execute the methods, operations, and logical block diagrams disclosed in embodiments of this disclosure. The general-purpose processor may be a microprocessor, any conventional processor, or the like. The operations of the method disclosed with reference to embodiments of this disclosure may be directly performed by a hardware processor, or may be performed by using a combination of hardware in the processor and a software module.

In embodiments of this disclosure, the memory may be a non-volatile memory, for example, a hard disk drive (HDD) or a solid-state drive (SSD), or may be a volatile memory, for example, a random-access memory (RAM). The memory is any other medium that can carry or store expected program code in a form of an instruction or a data structure and that can be accessed by a computer, but is not limited thereto. The memory in embodiments of this disclosure may alternatively be a circuit or any other apparatus that can implement a storage function, and is configured to store program instructions and/or data.

In an embodiment, the communication apparatus 900 may be used in a network device (for example, a serving satellite of a terminal device). In an embodiment, the communication apparatus 900 may be a network device, or may be an apparatus that can support the network device in implementing a function of the network device in any one of the foregoing embodiments. The memory 920 stores a computer program (or instructions) and/or data for implementing a function of the network device in any one of the foregoing embodiments. The processor 910 may execute the computer program stored in the memory 920, to complete the method performed by the network device in any one of the foregoing embodiments. When the communication apparatus 900 is used in the network device, the communication interface in the communication apparatus 900 may be configured to: interact with a terminal device, and send information to the terminal device or receive information from the terminal device.

In an embodiment, the communication apparatus 900 may be used in a terminal device. In an embodiment, the communication apparatus 900 may be the terminal device, or may be an apparatus that can support the terminal device in implementing a function of the terminal device in any one of the foregoing embodiments. The memory 920 stores a computer program (or instructions) and/or data for implementing the function of the terminal device in any one of the foregoing embodiments. The processor 910 may execute the computer program stored in the memory 920, to complete the method performed by the terminal device in any one of the foregoing embodiments. When the communication apparatus 900 is used in the terminal device, the communication interface in the communication apparatus 900 may be configured to: interact with a network device, and send information to the network device or receive information from the network device.

The communication apparatus 900 provided in this embodiment may be used in the network device to complete the method performed by the network device, or may be used in the terminal device to complete the method performed by the terminal device. Therefore, for technical effect that can be achieved by the communication apparatus 900, refer to the foregoing method examples. Details are not described herein again.

Based on the foregoing embodiments, an embodiment of this disclosure provides a communication system that includes a network device and a terminal device. The network device and the terminal device may implement the methods provided in embodiments shown in FIG. 3, FIG. 5, or FIG. 6.

All or some of the technical solutions provided in embodiments of this disclosure may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedure or functions according to embodiments of this disclosure are all or partially generated. The computer may be a general-purpose computer, a dedicated computer, a computer network, a terminal device, a network device, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device such as a server or a data center, integrating one or more usable media. The usable medium may be a magnetic medium (for example, a floppy disk, a hard disk drive, or a magnetic tape), an optical medium (for example, a digital video disc (DVD)), a semiconductor medium, or the like.

In embodiments of this disclosure, without a logical contradiction, embodiments may be mutually referenced. For example, methods and/or terms in the method embodiments may be mutually referenced. For example, functions and/or terms in the apparatus embodiments may be mutually referenced. For example, functions and/or terms in the apparatus embodiments and the method embodiments may be mutually referenced.

It is clear that one of ordinary skilled in the art can make various modifications and variations to embodiments of this disclosure without departing from the scope of embodiments of this disclosure. Embodiments of this disclosure are intended to cover these modifications and variations of embodiments of this disclosure provided that they fall within the scope of protection defined by the following claims of embodiments of this disclosure and their equivalent technologies.

What is claimed is:

1. A timing advance (TA) determining method, comprising:
receiving a first timing advance command (TAC) at a first moment;
in response to that a first parameter is updated in a first time period before the first moment, determining, a TA adjustment value based on a component of a first timing advance and the first TAC, wherein the first timing advance is determined by a communication apparatus at a second moment, the first time period is a time period between the second moment and the first moment, and the first parameter comprises one or more pieces of following information: positioning information of the communication apparatus, ephemeris information of a serving satellite, or a common timing advance TA; and
communicating with the serving satellite based on the TA adjustment value.

2. The method according to claim 1, wherein the serving satellite is a geostationary earth orbit (GEO) satellite, and the first parameter comprises the positioning information of the communication apparatus.

3. The method according to claim 1, wherein the serving satellite is a low earth orbit (LEO) satellite, the communication apparatus is in a stationary state, and the first parameter comprises the ephemeris information of the serving satellite.

4. The method according to claim 1, wherein the serving satellite is a low earth orbit LEO satellite, the communication apparatus is in a moving state, and the first parameter comprises at least the positioning information of the communication apparatus or the ephemeris information of the serving satellite.

5. The method according to claim 4, wherein
when a moving speed of the communication apparatus is greater than a first speed threshold, the first parameter comprises the positioning information of the communication apparatus and the ephemeris information of the serving satellite;
when the moving speed of the communication apparatus is less than a second speed threshold, the first parameter comprises the ephemeris information of the serving satellite;
when an orbital altitude of the serving satellite is less than a first altitude threshold, the first parameter comprises the ephemeris information of the serving satellite;
when the orbital altitude of the serving satellite is greater than a second altitude threshold, the first parameter comprises the positioning information of the communication apparatus;
when the moving speed of the communication apparatus is greater than the first speed threshold, and the orbital altitude of the serving satellite is greater than the second altitude threshold, the first parameter comprises the positioning information of the communication apparatus;
when the moving speed of the communication apparatus is less than the second speed threshold, and the orbital altitude of the serving satellite is less than the first altitude threshold, the first parameter comprises the ephemeris information of the serving satellite;
when an error corresponding to the ephemeris information of the serving satellite is less than a first error threshold, the first parameter comprises the positioning information of the communication apparatus; or
when an error corresponding to the positioning information of the communication apparatus is less than a second error threshold, the first parameter comprises the ephemeris information of the communication apparatus.

6. The method according to claim 5, wherein before determining the TA adjustment value, the method further comprises:
receiving first information from the serving satellite, wherein the first information indicates one or more of: the first speed threshold, the second speed threshold, the first altitude threshold, the second altitude threshold, the first error threshold, or the second error threshold.

7. The method according to claim 1, wherein the TA adjustment value T_{TA} satisfies following relational expression:
T_{TA}=(N_{TA_new}+N_{TA,UE-specific}+N_{TA,common}+N_{TA,offset})×T_{c}, wherein
$${N}_{TA \_ new} = α \times {N}_{{TA}_{old}} + ( {T}_{A} - 31 ) \times \frac{16.64}{{2}^{μ}} ,$$
N_{TA_old} is the first timing advance, α×N_{TA_old} represents the component of the first timing advance, 0≤α<1, T_{A} is a timing advance determined based on the first TAC, and μ is a coefficient determined based on a subcarrier spacing corresponding to the communication apparatus; and
N_{TA,UE-specific} is a timing advance determined based on the ephemeris information of the serving satellite and the positioning information of the communication apparatus, N_{TA,common} is a timing advance associated with the common TA information, N_{TA,offset} is a preconfigured timing offset, and T_{c} is a minimum time unit.

8. A communication apparatus, comprising:
a transceiver;
a processor; and
a memory coupled to the processor to store instructions, which when executed by the processor, cause the communication apparatus to:
receive a first timing advance command (TAC) at a first moment;
in response to that a first parameter is updated in a first time period before the first moment, determine, a TA adjustment value based on a component of a first timing advance and the first TAC, wherein the first timing advance is determined by the communication apparatus at a second moment, the first time period is a time period between the second moment and the first moment, and the first parameter comprises one or more pieces of following information: positioning information of the communication apparatus, ephemeris information of a serving satellite, or a common timing advance TA; and
communicating with the serving satellite based on the TA adjustment value.

9. The communication apparatus according to claim 8, wherein the serving satellite is a geostationary earth orbit (GEO) satellite, and the first parameter comprises the positioning information of the communication apparatus.

10. The communication apparatus according to claim 8, wherein the serving satellite is a low earth orbit (LEO) satellite, the communication apparatus is in a stationary state, and the first parameter comprises the ephemeris information of the serving satellite.

11. The communication apparatus according to claim 8, wherein the serving satellite is a low earth orbit LEO satellite, the communication apparatus is in a moving state, and the first parameter comprises at least the positioning information of the communication apparatus or the ephemeris information of the serving satellite.

12. The communication apparatus according to claim 11, wherein
when a moving speed of the communication apparatus is greater than a first speed threshold, the first parameter comprises the positioning information of the communication apparatus and the ephemeris information of the serving satellite;
when the moving speed of the communication apparatus is less than a second speed threshold, the first parameter comprises the ephemeris information of the serving satellite;
when an orbital altitude of the serving satellite is less than a first altitude threshold, the first parameter comprises the ephemeris information of the serving satellite;
when the orbital altitude of the serving satellite is greater than a second altitude threshold, the first parameter comprises the positioning information of the communication apparatus;
when the moving speed of the communication apparatus is greater than the first speed threshold, and the orbital altitude of the serving satellite is greater than the second altitude threshold, the first parameter comprises the positioning information of the communication apparatus;
when the moving speed of the communication apparatus is less than the second speed threshold, and the orbital altitude of the serving satellite is less than the first altitude threshold, the first parameter comprises the ephemeris information of the serving satellite;
when an error corresponding to the ephemeris information of the serving satellite is less than a first error threshold, the first parameter comprises the positioning information of the communication apparatus; or
when an error corresponding to the positioning information of the communication apparatus is less than a second error threshold, the first parameter comprises the ephemeris information of the communication apparatus.

13. The communication apparatus according to claim 12, wherein before determining the TA adjustment value, the instructions, when executed, further cause the communication apparatus to:
receiving first information from the serving satellite, wherein the first information indicates one or more of: the first speed threshold, the second speed threshold, the first altitude threshold, the second altitude threshold, the first error threshold, or the second error threshold.

14. The communication apparatus according to claim 8, wherein the TA adjustment value T_{TA} satisfies following relational expression:
T_{TA}=(N_{TA_new}+N_{TA,UE-specific}+N_{TA,common}+N_{TA,offset})×T_{c}, wherein
$${N}_{TA \_ new} = α \times {N}_{{TA}_{old}} + ( {T}_{A} - 31 ) \times \frac{16.64}{{2}^{μ}} ,$$
N_{TA_old} is the first timing advance, α×N_{TA_old} represents the component of the first timing advance, 0≤α<1, T_{A} is a timing advance determined based on the first TAC, and μ is a coefficient determined based on a subcarrier spacing corresponding to the communication apparatus; and
N_{TA,UE-specific} is a timing advance determined based on the ephemeris information of the serving satellite and the positioning information of the communication apparatus, N_{TA,common} is a timing advance associated with the common TA information, N_{TA,offset} is a preconfigured timing offset, and T_{c} is a minimum time unit.

15. A non-transitory computer-readable storage medium having instructions stored therein, which when executed by a processor, cause a communication apparatus to:
receiving a first timing advance command (TAC) at a first moment;
in response to that a first parameter is updated in a first time period before the first moment, determining, a TA adjustment value based on a component of a first timing advance and the first TAC, wherein the first timing advance is determined by the communication apparatus at a second moment, the first time period is a time period between the second moment and the first moment, and the first parameter comprises one or more pieces of following information: positioning information of the communication apparatus, ephemeris information of a serving satellite, or a common timing advance TA; and
communicating with the serving satellite based on the TA adjustment value.

16. The non-transitory computer-readable storage medium according to claim 15, wherein the serving satellite is a geostationary earth orbit (GEO) satellite, and the first parameter comprises the positioning information of the communication apparatus.

17. The non-transitory computer-readable storage medium according to claim 15, wherein the serving satellite is a low earth orbit (LEO) satellite, the communication apparatus is in a stationary state, and the first parameter comprises the ephemeris information of the serving satellite.

18. The non-transitory computer-readable storage medium according to claim 15, wherein the serving satellite is a low earth orbit LEO satellite, the communication apparatus is in a moving state, and the first parameter comprises at least the positioning information of the communication apparatus or the ephemeris information of the serving satellite.

19. The non-transitory computer-readable storage medium according to claim 18, wherein
when a moving speed of the communication apparatus is greater than a first speed threshold, the first parameter comprises the positioning information of the communication apparatus and the ephemeris information of the serving satellite;
when the moving speed of the communication apparatus is less than a second speed threshold, the first parameter comprises the ephemeris information of the serving satellite;
when an orbital altitude of the serving satellite is less than a first altitude threshold, the first parameter comprises the ephemeris information of the serving satellite;
when the orbital altitude of the serving satellite is greater than a second altitude threshold, the first parameter comprises the positioning information of the communication apparatus;
when the moving speed of the communication apparatus is greater than the first speed threshold, and the orbital altitude of the serving satellite is greater than the second altitude threshold, the first parameter comprises the positioning information of the communication apparatus;
when the moving speed of the communication apparatus is less than the second speed threshold, and the orbital altitude of the serving satellite is less than the first altitude threshold, the first parameter comprises the ephemeris information of the serving satellite;
when an error corresponding to the ephemeris information of the serving satellite is less than a first error threshold, the first parameter comprises the positioning information of the communication apparatus; or
when an error corresponding to the positioning information of the communication apparatus is less than a second error threshold, the first parameter comprises the ephemeris information of the communication apparatus.

20. The non-transitory computer-readable storage medium according to claim 15, wherein the TA adjustment value T_{TA} satisfies following relational expression:
T_{TA}=(N_{TA_new}+N_{TA,UE-specific}+N_{TA,common}+N_{TA,offset})×T_{c}, wherein
$${N}_{TA \_ new} = α \times {N}_{{TA}_{old}} + ( {T}_{A} - 31 ) \times \frac{16.64}{{2}^{μ}} ,$$
N_{TA_old} is the first timing advance, α×N_{TA_old} represents the component of the first timing advance, 0≤α<1, T_{A} is a timing advance determined based on the first TAC, and μ is a coefficient determined based on a subcarrier spacing corresponding to the communication apparatus; and
N_{TA,UE-specific} is a timing advance determined based on the ephemeris information of the serving satellite and the positioning information of the communication apparatus, N_{TA,common} is a timing advance associated with the common TA information, N_{TA,offset} is a preconfigured timing offset, and T_{c} is a minimum time unit.
